(19) United States
(12) Patent Application Publication
(10) Pub. No.: US 2005/0094746 A1
(43) Pub. Date: May 5, 2005

(54) Characteristic measurement system for a digital modulation signal transmission circuit

(76) Inventor: Yoneo Akita, Tokyo (JP)

Correspondence Address: Francis I. Gray;TEKTRONIX, INC., MS 50-LAW, P.O. BOX 500, BEAVERTON, OR, 97077, US

(21) Appl. No.: 10/936,898

(22) Filed: Sep. 8, 2004

(30) Foreign Application Priority Data
Oct. 30, 2003 (JP) 2003-371169

(51) Int. Cl. H04L 27/04

(52) U.S. Cl. 375/340

(57) ABSTRACT

Measurement of a characteristic of a digital modulation signal transmission circuit is calculated using only a distorted digital modulation signal from the transmission circuit. A measurement and processing circuit receives and demodulates the distorted digital modulation signal from the transmission circuit, separates known and unknown data from the demodulated signal, and estimates ideal symbols for the unknown data using known information derived from the known data, such as modulation format information and pilot signals. Then the measurement and processing circuit calculates the characteristic, such as transmission circuit linearity, between the distorted digital modulation signal and a calculated ideal digital modulation signal based on the ideal symbols and known information. The characteristic measurement is displayed graphically.

### BACKGROUND OF THE INVENTION

The present invention relates to characteristic measurement of a digital modulation signal transmission circuit, and more particularly to simple characteristic measurement system for a digital modulation signal transmission circuit which uses a single input channel for in-service measurements.

Mobile phone systems, terrestrial digital broadcasting systems, wireless LANs, etc. use digital modulation communication systems. For example, for wireless LAN a signal is first modulated by different symbol rates, such as QPSK (Quadrature Phase Shift Keying), 16QAM (Quadrature Amplitude Modulation), etc. according to transmission requirements, and then by OFDM (Orthogonal Frequency Division Multiplexing) to transmit the signal as a wireless signal.

Digital modulation has tolerance for distortion. For example, a symbol of a QPSK modulated signal takes one of the four defined positions on an IQ plain and, even if the positions of actual symbols depart from the ideal ones to some extent during the transmission because of distortions of phase, amplitude, etc., distortions may be determined by comparing the actual symbols with respective thresholds. Therefore, the information contained in the signal is maintained.

A multi-channel transmission system, such as OFDM, has a high ratio between maximum and average powers which requires a wide dynamic range for the transmission circuit. Therefore it is important that an operation point of the transmission circuit is set properly to maintain good communication quality. For testing a test signal having known amplitude, frequency, etc. is provided to the transmission circuit, with the resulting output signal being measured to determine characteristics of the transmission circuit.

FIG. 1 shows a block diagram of a conventional characteristic measurement system. When a characteristic, such as linearity, of a transmission circuit 12 is measured at one frequency, a signal source 10 provides a known sinusoidal signal to the transmission circuit 12 while gradually changing the amplitude. A measurement and processing circuit 14 has two input channels to receive the known input and distorted output signals of the transmission circuit 12. The measurement and processing circuit 14 converts the known input and distorted output signals into digital data in order to calculate the characteristic of the transmission circuit 12. A display 16 provides a characteristic graph of the transmission circuit as a function of the respective powers of the known input and distorted output signals as calculated by the measurement and processing circuit 14. Similarly, when the characteristic of the transmission circuit 12 at different frequencies is measured, the signal source 10 provides a known sinusoidal signal while gradually changing the frequency.

The above conventional test methods require a number of test signals of known characteristics according to which characteristics of the transmission circuit are being measured. Also these methods require that the measurement and processing circuit have two input channels for measuring the known input and distorted output digital modulation signals. Further, the conventional methods require that the transmission circuit stop its ordinary operation, making it difficult to measure a transmission system which is required to operate continuously and thus has few opportunities for stopping its operation, i.e., the measurement is an out-of-service measurement. These methods provide accurate measurement of the characteristics of the transmission circuit, but the accuracy and cost are too much for just confirming whether or not there is a fatal error.

U.S. Pat. No. 6,275,523 discloses a system for in-service nonlinearity measurements of the transmission circuit by comparing transmitted signal samples from the output of the transmission circuit with reference signal samples regenerated from estimated transmitted symbols derived from the transmitted signal samples, but the system is complex and costly.

What is desired is a simple characteristic measurement system for a digital modulation signal transmission circuit that is a cost effective, requires only one input channel and provides in-service measurement.

### SUMMARY OF THE INVENTION

Accordingly the present invention provides a characteristic measurement system for a digital modulation signal transmission circuit that uses a simple and low-lost method. A measurement instrument receives a distorted digital modulation signal from a transmission circuit. The distorted digital modulation signal is demodulated and known data are separated from unknown data. Ideal symbols are estimated for the unknown data by using known information, such as modulation format information, pilot signals, etc. Then, an ideal digital modulation signal is calculated using the ideal symbols and the known information. Finally, the characteristic, such as amplitude linearity, between the distorted digital modulation signal and the ideal digital modulation signal is calculated. The calculated characteristic is displayed graphically. Although the distorted digital modulation signal from the transmission circuit is unknown, the measurement instrument does not require a known test signal. Therefore the measurement instrument measures the characteristic of the transmission circuit even if it is in-service, and requires only one input channel.

The objects, advantages and other novel features of the present invention are apparent from the following detailed description when read in conjunction with the appended claims and attached drawing.

### BRIEF DESCRIPTION OF THE DRAWING

FIG. 1 is a block diagram view of a conventional characteristic measurement system.

FIG. 2 is a block diagram view of a characteristic measurement system for a digital modulation signal transmission circuit according to the present invention.

FIG. 3 is a flowchart view of the characteristic measurement system according to the present invention

FIG. 4 is a graphic view of a characteristic graph illustrating linearity for the transmission circuit according to the present invention.

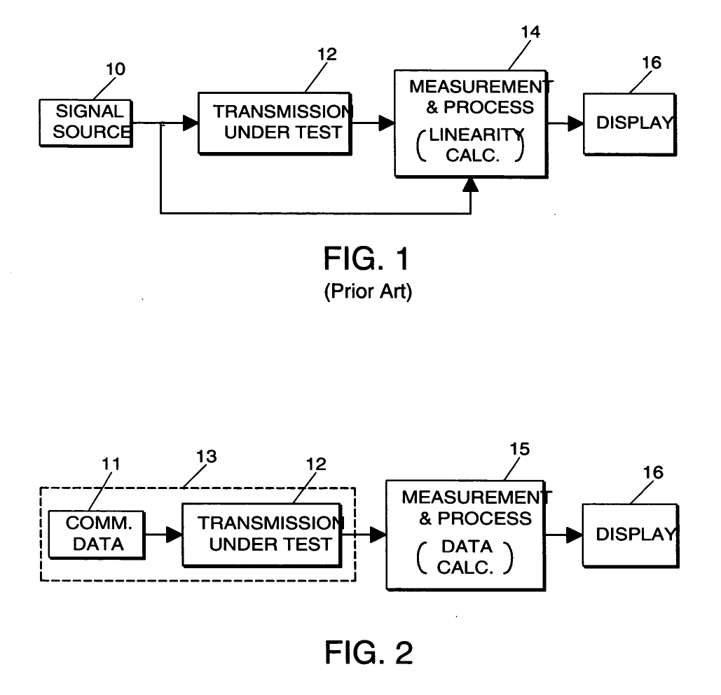

### DETAILED DESCRIPTION OF THE INVENTION

Referring now to FIG. 2, a transmission circuit 12 receives an input digital modulation signal from a communication data source 11 and provides a distorted digital modulation signal. A measurement and processing circuit 15 receives the distorted digital modulation signal from the transmission circuit 12 to determine its characteristics. The results from the measurement and processing circuit 15 are provided to a display 16.

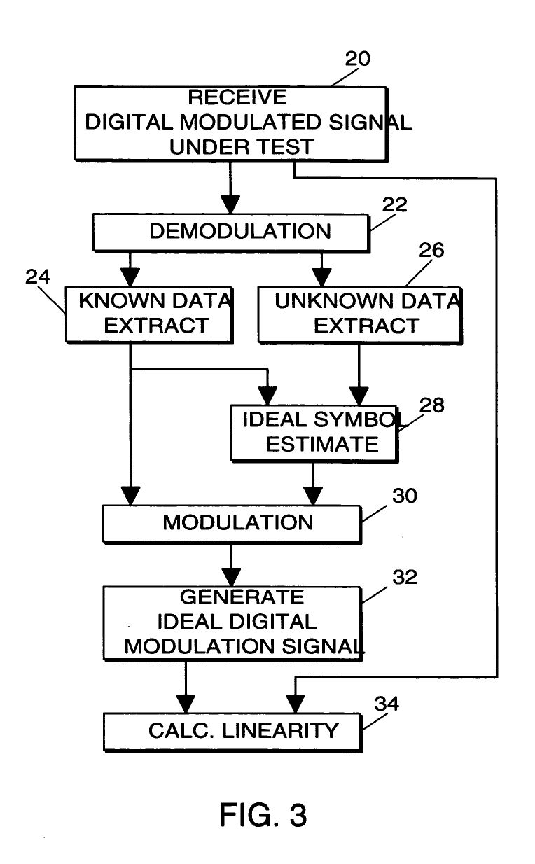

FIG. 3 shows a flowchart of a characteristic measurement process performed by the measurement and processing circuit 15. For this example the characteristic being measured is transmission circuit linearity. The measurement and processing circuit 15 may be a combination of a communication measurement instrument, such as a spectrum analyzer, etc., and a personal computer (PC). The measurement and processing circuit 15 conducts the measurement process according to a program previously stored in a built-in storage device, such as a hard disk drive (not shown).

The measurement and processing circuit 15 receives the distorted digital modulation signal from the transmission circuit 12 (step 20), and demodulates it (step 22). The digital modulation signal has known information that is modulation format information (the first modulation is QPSK, 16QAM, etc.) in the header and pilot signals for correcting phase error. Unknown data depending on the communication contents, such as audio and video information, and known data are separated and extracted during the demodulation (steps 24 and 26). Then, the measurement and processing circuit 15 plots symbols for the unknown data on an IQ plain by using the information provided by the known data, and estimates the original symbol values that the communication data source 11 provided (step 28). The ideal symbol positions, or symbol values, on the IQ plain for the unknown data are defined according to the modulation format to estimate the ideal symbol values from the communication data source 11, if the digital modulation signal from the transmission circuit is not extremely distorted.

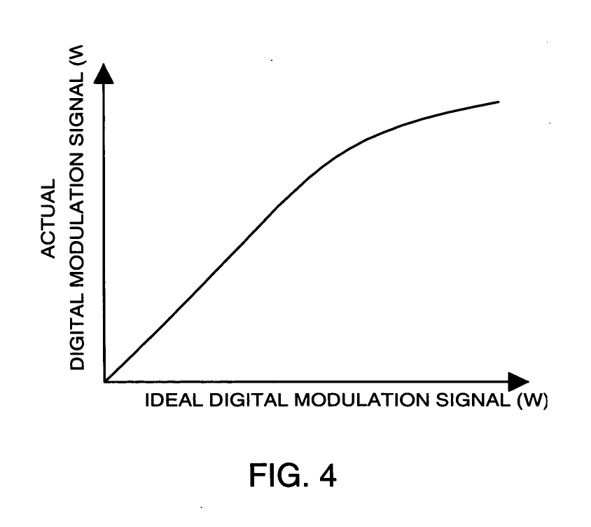

The ideal symbols are digitally modulated by OFDM (step 30), and an ideal digital modulation signal without distortion is generated (step 32). The measurement and processing circuit 15 calculates characteristics of the transmission circuit, such as amplitude linearity, using the relationship between the calculated ideal digital modulation signal and the distorted digital modulation signal received from the transmission circuit (step 34). The display 16 shows the characteristic information between the actual and ideal digital modulation signals of the transmission circuit 12 graphically, as shown in FIG. 4.

FIG. 4 shows an example of a linearity graph for the transmission circuit 12. Horizontal and vertical axes show powers of the ideal and distorted digital modulation signals, respectively. This example indicates that the transfer characteristic of the transmission circuit 12 between input and output is not linear for high power amplitude signals.

The measurement and processing circuit 15 does not require a digital modulation signal having known content. Therefore, it measures characteristics of the transmission circuit by receiving the distorted digital modulation signal having content that is not previously known, such as live digital broadcasting for terrestrial broadcasting systems. However, the digital modulation format used in the received signal is one of the known formats. This is because the candidate formats are narrowed down according to the known standard for terrestrial digital broadcasting, wireless LAN, etc. Only the digital modulation signal from the transmission circuit 12 is used for the measurement, so it is not necessary to provide a measurement channel for providing the digital modulation signal input to the transmission circuit 12. Therefore, if the communication data source 11 and the transmission circuit 12 are integrated in one circuit such as an integrated circuit (IC), the measurement and processing circuit 15 still measures the characteristic of the transmission circuit 12 in a communication instrument 13 that has the communication data source 11 and the transmission circuit 12 by measuring the distorted digital modulation signal output from the communication instrument 13.

Thus the present invention provides a simple characteristic measurement system for a digital modulation signal transmission circuit by demodulating a distorted digital modulation signal from the transmission circuit, separating known data and unknown data in the demodulated signal, estimating ideal symbols for the unknown data based on known information about the communication system derived from the known data, providing an ideal digital modulation signal from the ideal symbols, and determining a characteristic for the transmission circuit between the distorted and ideal digital modulation signals.

1. A method for measuring characteristics of a digital modulation signal transmission circuit comprising the steps of:
demodulating known and unknown data from a digital modulation signal received from the transmission circuit;
estimating ideal symbols for the unknown data using the known data;
generating an ideal digital modulation signal using the ideal symbols and the known data; and
calculating the characteristics of the transmission circuit as a function of the digital modulation signal and the ideal digital modulation signal.

2. The method as recited in claim 1 wherein the estimating step comprises the step of determining the ideal symbols by comparing estimated symbols with respective thresholds.

3. The method as recited in claim 1 wherein the known data comprises known information which is used in the estimating step.

4. The method as recited in claim 1 wherein the known data comprises known information which is used in the generating step to generate the ideal digital modulation signal.

5. The method as recited in claims 3 or 4 wherein the known information comprises modulation format information.

6. The method as recited in claims 3 or 4 wherein the known information comprises pilot signals.

7. The method as recited in claim 1 wherein the generating step comprises OFDM modulation.

8. The method as recited in claim 1 wherein the characteristics comprise a linearity measure for the transmission circuit.

9. An apparatus for measuring characteristics of a digital modulation signal transmission circuit comprising:
means for demodulating known and unknown data from a digital modulation signal received from the transmission circuit;
means for estimating ideal symbols for the unknown data using the known data;
means for generating an ideal digital modulation signal using the ideal symbols and the known data; and
means for calculating the characteristics of the transmission circuit as a function of the digital modulation signal and the ideal digital modulation signal.

10. The apparatus as recited in claim 9 wherein the estimating means comprises means for determining the ideal symbols by comparing estimated symbols derived from the unknown data with respective thresholds.

11. The apparatus as recited in claim 9 wherein the demodulating means comprises means for determining known information from the known data for use in the estimating means.

12. The apparatus as recited in claim 9 wherein the demodulating means comprises means for determining known information from the known data for use in the generating means.

13. The apparatus as recited in claims 11 or 12 wherein the known information comprises modulation format information.

14. The apparatus as recited in claims 11 or 12 wherein the known information comprises pilot signals.

15. The apparatus as recited in claim 9 wherein the generating means comprises OFDM modulation to generate the ideal digital modulation signal.

16. The apparatus as recited in claim 9 wherein the the characteristics comprise a linearity measurement for the transmission circuit.
